(19) United States
(12) Patent Application Publication
(10) Pub. No.: US 2009/0227732 A1
(43) Pub. Date: Sep. 10, 2009

(54) USE OF AN AQUEOUS DISPERSION BASED ON AN UNSATURATED, AMORPHOUS POLYESTER BASED ON DEFINED DICIDOL ISOMERS

(75) Inventors: Patrick Glöckner, Haltern am See (DE); Lutz Mindach, Bochum (DE); Peter Denkinger, Nottuln (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA GmbH, Duesseldorf (DE)

(21) Appl. No.: 11/577,955

(22) PCT Filed: Sep. 2, 2005
(86) PCT No.: PCT/EP05/54333

§ 371 Date: Jan. 11, 2008

(30) Foreign Application Priority Data
Oct. 26, 2004 (DE) 10 2004 051 861.0

(51) Int. Cl. C08K 3/20

(52) U.S. Cl. 524/591; 524/604

(57) ABSTRACT

The invention relates to the use of an aqueous dispersion based on unsaturated amorphous polyesters based on particular Dicidol isomers and carboxylic acids.

The invention relates to the use of an aqueous dispersion based on unsaturated amorphous polyesters based on particular Dicidol isomers and carboxylic acids.

Unsaturated polyester resins (UP resins) are known. They are prepared by condensing saturated and unsaturated dicarboxylic acids or their anhydrides with diols. Their properties depend largely on the nature and proportion of the starting materials.

As carriers of the polymerizable double bonds it is usual to use α,β-unsaturated acids, primarily maleic acid or its anhydride or fumaric acid; unsaturated diols are of minor importance. The higher the double bond content, i.e., the shorter the distance between the double bonds in the chain molecules, the more reactive the polyester resin. It polymerizes very rapidly, evolving large quantities of heat and undergoing a high level of volume contraction, to form a highly crosslinked and therefore relatively brittle end product. Consequently the reactive double bonds in the polyester molecule are “diluted” by cocondensing saturated aliphatic or aromatic dicarboxylic acids. Straight-chain and branched diols are used as alcohol components. The individual UP resin types differ not only in the components used to prepare them but also in the proportion of saturated to unsaturated acids, which determines the degree of crosslinking in the polymerization, the degree of condensation, i.e., the molar mass, the acid number and OH number, i.e., the nature of the end groups in the chain molecules, the monomer content, and the nature of the additions (Ullmann's Encyclopedia of Industrial Chemistry, Vol. A21, p. 217 ff, 1992).

UP resins based on Dicidol as the diol component are known from, for example, DE 924 889, DE 953 117, DE 22 45 110, DE 27 21 989, EP 1 14 208, and EP 934 988.

It was an object of the present invention, from the multiplicity of possibilities and breadth of variation of the state of the art, to find new, unsaturated and amorphous polyester resins which additionally are water-dispersible and, in solid form, transparent. These resins ought to improve properties such as adhesion and initial drying rate, for example, for aqueous coating materials and adhesives, for example.

This object has been achieved in the way which will now be elucidated.

The invention provides for the use of an aqueous dispersion based on an amorphous unsaturated polyester resin,

the polyester resin being synthesized from
I. an alcohol component,
II. 1, from 20 to 100 mol % of an α,β-unsaturated carboxylic acid component
   and
   2. from 0 to 80 mol % of a further carboxylic acid component,
      the sum of II.1 and II.2 being 100 mol %,
      and
III. 0 to 2 mol, based on 1 mol of polyester from I and II (via Mn), of at least one hydrophilically modified isocyanate and/or polyisocyanate having at least one free NCO group, obtainable by reacting at least one isocyanate and/or polyisocyanate with compounds which in addition to the hydrophilic or potentially hydrophilic group have at least one function which is reactive toward isocyanate groups,
   the alcohol component I being composed of a Dicidol mixture of the isomeric compounds 3,8-bis(hydroxymethyl)tricyclo[5.2.1.0^{2,6}]decane, 4,8-bis(hydroxymethyl)tricyclo[5.2.1.0^{2,6}]decane and 5,8-bis(hydroxymethyl)tricyclo[5.2.1.0^{2,6}]decane,
   it being possible for each isomer to be present in a fraction of from 20% to 40% in the mixture, and the sum of the three isomers being from 90% to 100%,
   and the mixture being present at least at 10 mol % in the alcohol component of the polyester,
   and there being at least one component II.2 and/or III,
      and the aqueous dispersion having
a) a nonvolatiles content of from 20% to 60% by weight,
b) a solvent content of from 0 to 20% by weight,
c) a pH of between 5.0 and 9.5, and
d) a viscosity at 20° C. of from 20 to 500 mPas.

In particular the dispersions find use
as main, base or additional component in coating materials, adhesives, inks, including printing inks, gel coats, polishes, stains, pigment pastes, filling compounds, cosmetics articles, sealants and/or insulants;
as main, base or additional component in filling compounds, primers, surfacers, basecoat, topcoat and clearcoat materials;
for protecting or finishing metals, plastics, wood, board, paper, textiles, leather, mineral substrates and glass;
as main, base or additional component in physically drying, oxidatively curing or chemically crosslinking coating materials, adhesives, inks, including printing inks, gel coats, polishes, stains, pigment pastes, filling compounds, cosmetics articles, sealants and/or insulants,
it being possible for further water-soluble or water-dispersible oligomers and/or polymers to be included;
as main, base or additional component in physically drying, oxidatively curing, chemically crosslinking coating materials, adhesives, inks, including printing inks, gel coats, polishes, stains, pigment pastes, filling compounds, cosmetics articles, sealants and/or insulants,
with the inclusion of further water-soluble or water-dispersible oligomers and/or polymers selected from the group consisting of polyurethanes, polyacrylates, polyethers, polyesters, alkyd resins, cellulose ethers, cellulose derivatives, polyvinyl alcohols and derivatives, rubbers, maleate resins, phenol-/urea-aldehyde resins, amino resins (e.g., melamine resins, benzoguanamine resins), epoxy acrylates, epoxy resins, silicic esters and alkali metal silicates (e.g., waterglass), natural resins, silicone oils and silicone resins, amine resins and/or fluorine-containing polymers and their derivatives, alone or in combination.

The dispersions are known from EP 1 433 803 and EP 1 433 805.

The unsaturated amorphous polyester resins are obtained by reacting the alcohol component I with the carboxylic acid component II and also, if desired, with a hydrophilically modified diisocyanate III.

The alcohol component I used comprises, in accordance with the invention, a Dicidol mixture of the isomeric compounds 3,8-bis(hydroxymethyl)tricyclo[5.2.1.0^{2,6}]-decane, 4,8-bis(hydroxymethyl)tricyclo[5.2.1.0^{2,6}]decane and 5,8-bis(hydroxymethyl)tricyclo[5.2.1.0^{2,6}]decane, it being possible for each isomer to be present in a fraction of from 20% to 40% in the mixture and the sum of the three isomers is from 90% to 100%, preferably from 95% to 100%, and the mixture is present at least at 10% in the alcohol component of the polyester. The isomer content of the Dicidol mixture can be determined qualitatively and quantitatively by means, for example, of GC analysis or quantitatively by fractionation, by means of preparative GC or HPLC and subsequent NMR spectroscopy. All corresponding isomers of Dicidol in position 9 are equally suitable but, owing to the mirror symmetry of the abovementioned isomers, and also of the cis and trans isomers, are impossible to distinguish under normal circumstances relevant to practice.

The Dicidol mixture may also include up to 10% of further isomers of Dicidol and/or trimeric and/or higher isomeric diols of the Diels-Alder reaction product from cyclopentadiene. The alcohol component is composed preferably of 20%, of 50%, more preferably of 90%, with particular preference of 100% of Dicidol mixture, which with particular preference contains from 95% to 100% of the three isomeric compounds stated above.

Besides the Dicidol mixture the alcohol component I can contain further linear and/or branched, aliphatic and/or cycloaliphatic and/or aromatic diols and/or polyols. Preferred additional alcohols used include ethylene glycol, 1,2- and/or 1,3-propanediol, diethylene glycol, dipropylene glycol, triethylene glycol, tetraethylene glycol, 1,2- and/or 1,4-butanediol, 1,3-butylethylpropanediol, 1,3-methyl-propanediol, 1,5-pentanediol, bisphenol A, B, C, F, norbornylene glycol, 1,4-benzyldimethanol and -ethanol, 2,4-dimethyl-2-ethylhexane-1,3-diol, cyclohexanedimethanol, glycerol, hexanediol, neopentyl glycol, trimethylolethane, trimethylolpropane and/or pentaerythritol.

The unsaturated amorphous polyester resins contain as starting acid component at least one α,β-unsaturated dicarboxylic acid. Preferably the unsaturated polyester resins contain citraconic, fumaric, itaconic, maleic and/or mesaconic acid.

It is also possible in addition for aromatic and/or aliphatic and/or cycloaliphatic monocarboxylic acids and/or dicarboxylic acids and/or polycarboxylic acids to be present, examples being phthalic acid, isophthalic acid, terephthalic acid, 1,4-cyclohexanedicarboxylic acid, succinic acid, sebacic acid, methyltetrahydrophthalic acid, methylhexahydrophthalic acid, hexahydrophthalic acid, tetrahydrophthalic acid, dodecanedioic acid, adipic acid, azelaic acid, pyromellitic acid and/or trimellitic acid, isononanoic acid, and 2-ethylhexanoic acid. Phthalic acid, hexahydrophthalic acid, tetrahydrophthalic acid, hexahydroterephthalic acid, trimellitic acid, adipic acid and/or azelaic acid are preferred.

The carboxylic acid component II may be composed in whole or in part of anhydrides and/or low molecular mass alkyl esters, preferably methyl esters and/or ethyl esters.

Generally speaking the alcohol component is present in a molar ratio of from 0.5 to 2.0:1 with respect to the carboxylic acid component, preferably from 0.8 no 1.5:1. With particular preference the reaction of the alcohol component takes place in a molar ratio of from 1.0 to 1.3:1 with respect to the carboxylic acid component.

The acid number that is required for hydrophilicization may be the result of an incomplete reaction of the carboxylic acid component II.2. In this context it has proven advantageous to react, in particular, carboxylic acids with a functionality of three or more, such as pyromellitic acid and/or trimellitic acid, for example, such that at least one carboxylic acid group is not reacted. Based on the total carboxylic acid component, the fraction of the further carboxylic acid component II.2 can then be from 2 to 80 mol %.

Alternatively, for the purpose of hydrophilicization, the reaction can be carried out with a hydrophilicized diisocyanate or polyisocyanate (urethanization) (component III). For this purpose, then, 0.1 to 2 mol of hydrophilicized diisocyanate or polyisocyanate (component III) are used per mole of the polyester formed from I and II (number-average molecular weight, Mn).

The hydrophilic modification that may be necessary to the unsaturated amorphous polyester, accomplished by urethanization, takes place by reaction of the unsaturated amorphous polyester with at least one hydrophilically modified isocyanate and/or polyisocyanate having at least one free NCO group, obtainable by reacting at least one isocyanate and/or polyisocyanate with compounds which in addition to the hydrophilic or potentially hydrophilic group—i.e., groups which become hydrophilic only after neutralization—have at least one function that is reactive toward isocyanate groups, such as hydroxyl groups or amino groups, for example.

Examples of compounds of this kind for the hydrophilic modification of (poly)isocyanates are amino acids and also monohydroxy- and polyhydroxyalkylcarboxylic acids. The hydrophilic modification may also be performed with nonionic groups (e.g., with polyethers) or with compounds which have already been neutralized.

It is preferred to use 2,2-dimethylolacetic acid, 2,2-dimethylolpropionic acid, 2,2-dimethylolbutyric acid, 2,2-dimethylolpentanoic acid, dihydroxysuccinic acid, 1,1,1-trimethylolacetic acid, hydroxypivalic acid or mixtures of such acids. Of further suitability are mono- and/or polyhydroxyphosphonic acids such as 2,3-dihydroxypropanephosphonic acid.

Hydroxycarboxylic acids such as, in particular, dimethylolpropionic acid are particularly preferred on account of the fact that, when neutralized with volatile bases, such as amines, for example, they display a strong hydrophilic action, but undergo a sharp reduction in this action after the volatile base has evaporated. Consequently, coatings do not lose their protective function as a result, for example, of moisture exposure, since no swelling takes place.

Dimethylolpropionic acid is also particularly preferred on account of the fact that via its two hydroxyl groups it is capable of performing (potentially) hydrophilic modification on two hydrophobic polyisocyanates.

Suitable polyisocyanates are preferably polyisocyanates with a functionality of from two to four. Examples of such include cyclohexane diisocyanate, methylcyclohexane diisocyanate, ethylcyclohexane diisocyanate, propylcyclohexane diisocyanate, methyldiethylcyclohexane diisocyanate, phenylene diisocyanate, tolylene diisocyanate, bis(isocyanatophenyl)methane, propane diisocyanate, butane diisocyanate, pentane diisocyanate, hexane diisocyanate, such as hexamethylene diisocyanate (HDI) or 1,5-diisocyanato-2-methylpentane (MPDI), heptane diisocyanate, octane diisocyanate, nonane diisocyanate, such as 1,6-diisocyanato-2,4,4-trimethylhexane or 1,6-diisocyanato-2,2,4-trimethylhexane (TMDI), nonane triisocyanate, such as 4-isocyanatomethyl-1,8-octane diisocyanate (TIN), decane diisocyanate and triisocyanate, undecane diisocyanate and triisocyanate, dodecane diisocyanates and triisocyanates, isophorone diisocyanate (IPDI), dicyclohexylmethane 4,4′-diisocyanate (H₁₂MDI), isocyanatomethylmethylcyclohexyl isocyanate, 2,5(2,6)-bis(isocyanatomethyl)bicyclo[2.2.1]heptane (NBDI), 1,3-bis(isocyanatomethyl)cyclohexane (1,3-H₆—XDI) or 1,4-bis(isocyanatomethyl)cyclohexane (1,4-H₆—XDI), alone or in a mixture.

Another preferred class of polyisocyanates are the compounds having more than two isocyanate groups per molecule that are prepared by dimerizing, trimerizing, allophanatizing, biuretizing and/or urethanizing the simple diisocyanates, examples of these polyisocyanates being the reaction products of said simple diisocyanates, such as IPDI, HDI and/or H₁₂MDI, with polyhydric alcohols (e.g., glycerol, trimethylolpropane, pentaerythritol) and/or with polyfunctional polyamines, for example, or the triisocyanurates which are obtainable by trimerizing the simple diisocyanates, such as IPDI, HDI and H12MDI, for example.

A particularly preferred polyisocyanate is a hydrophilically modified polyisocyanate (III) formed from dimethylolpropionic acid or derivatives thereof and IPDI and/or TMDI and/or H₁₂MDI and/or HDI in a molar ratio of 1:2.

The unsaturated amorphous polyesters can have an acid number of between 1 and 200 mg KOH/g, preferably between 1 and 100, more preferably between 10 and 50 mg KOH/g, and an OH number of between 1 and 200 mg KOH/g, preferably between 1 and 100, more preferably between 10 and 80 mg KOH/g.

The Tg of the unsaturated amorphous polyesters varies from −30 to +80° C., preferably from −20 to +50° C. more preferably from −10 to +40° C.

In one preferred embodiment, 1, the unsaturated polyesters (UP resins) are composed of an alcohol component containing at least 50%, preferably 90%, more preferably 100% of the Dicidol mixture of the isomeric compounds 3,8-bis(hydroxymethyl)tricyclo[5.2.1.0^{2,6}]-decane, 4,8-bis(hydroxymethyl)tricyclo[5.2.1.0^{2,6}]decane and 5,8-bis(hydroxymethyl)tricyclo[5.2.1.0^{2,6}]decane and of a) fumaric acid and/or b) maleic acid (anhydride) and/or c) trimellitic anhydride.

Composition of the carboxylic acid component of embodiment 1
a) 0-90 mol % fumaric acid
b) 90-0 mol % maleic acid (anhydride),
   the sum of a)+b) being from 60 to 90 mol %
c) 10-40 mol % trimellitic anhydride,
   and the sum of a) to c) being 100 mol %.

In a further preferred embodiment, 2, the polyesters contain the abovementioned starting components as under 1, but additionally contain a further carboxylic acid component d) selected from adipic acid, dodecanedioic acid and/or phthalic acid (anhydride), it being possible for the ratio of the α,β-unsaturated acid to the additional carboxylic acid to vary from 2:1 to 1:4. Preference is given to ratios of approximately from 1:1 to 1:2.

Composition of the carboxylic acid component of embodiment 2
a) 0-80 mol % fumaric acid
b) 80-0 mol % maleic acid (anhydride),
   the sum of a) and b) being at least 20 mol %
c) 5-40 mol % trimellitic anhydride
d) 5-75 mol % further carboxylic acid component,
   and the sum of c) and d) being at least 20 mol % and the sum of a) to d) being 100 mol %.

In a preferred embodiment 3 the unsaturated polyesters of the invention are composed of an alcohol component with at least 50%, preferably 90%, more preferably 100% of the Dicidol mixture of the isomeric compounds 3,8-bis(hydroxymethyl)tricyclo[5.2.1.0^{2,6}]decane, 4,8-bis-(hydroxymethyl)tricyclo[5.2.1.0^{2,6}]decane and 5,8-bis-(hydroxymethyl)tricyclo[5.2.1.0^{2,6}]decane and of fumaric acid and/or maleic acid (anhydride) and, as component III, of isophorone diisocyanate and/or hexamethylene diisocyanate (HDI) and/or bis(isocyanatomethylcyclohexyl)methane (H₁₂MDI) and/or 1,6-

diisocyanato-2,4,4-trimethylhexane or 1,6-diisocyanato-2,2,4-trimethylhexane (TMDI), and 2,2-dimethylolpropionic acid.

In a further preferred embodiment, 4, the polyesters contain the abovementioned starting components as under 3, but additionally contain a further carboxylic acid selected from adipic acid, dodecanedioic acid and/or phthalic acid (anhydride), it being possible for the ratio of the α,β-unsaturated acid to the additional carboxylic acid to vary from 2:1 to 1:4. Preference is given to ratios of approximately from 1:1 to 1:2.

The polyesters of the invention can also comprise auxiliaries and additives selected from inhibitors, organic solvents, water, surfactants, oxygen scavengers and/or free-radical scavengers, catalysts, light stabilisers, color brighteners, photosensitizers and photoinitiators, additives for influencing rheological properties, such as thixotropic agents and/or thickening agents, flow control agents, anti-skinning agents, defoamers, antistats, lubricants, wetting agents, dispersants, neutralizing agents, preservatives such as agents, for example, including fungicides and/or biocides, thermoplastic additives, plasticizers, matting agents, flame retardants, internal release agents, fillers, dyes, pigments and/or propellants.

The polyesters of the invention are prepared by (semi)continuous or batchwise esterification of the starting acids and starting alcohols in a single-stage or multistage procedure and, if desired, further reaction with component III.

The polyesters of the invention can be neutralized with a suitable neutralizing agent, to give a water-dilutable polyester. This polyester can be dispersed in water, using where appropriate a suitable auxiliary solvent such as acetone, methyl ethyl ketone and the like, for example. The auxiliary solvent, employed can if desired be removed finally from the resulting dispersion by distillation.

The inventive aqueous dispersions of amorphous unsaturated polyester resins are elucidated in more detail by the examples which follow, but are not intended to restrict their scope of application:

### EXAMPLES

Starting component Dicidol mixture in an isomer ratio of approximately 1:1:1

### Example Polyester 1

1.1 mol of adipic acid are reacted with 3.4 mol of Dicidol at 210°C. under a nitrogen atmosphere until an acid number below 5 mg KOH/g is reached. Then 1.1 mol of fumaric acid and 0.02% of hydroquinone are added. After 2 hours of stirring a vacuum of 20 mbar is applied until an acid number below 5 mg KOH/g is reached. 1300 g of the polyester prepared are admixed with 150 g of trimellitic anhydride and the mixture is stirred at 200° C. for 1.5 h until an acid number of about 30 mg KOH/g is reached.

### Characteristics:

Mₙ: 2500 g/mol, M_{w}: 12 000 g/mol, acid number: 31 mg KOH/g, hydroxyl number: 66 mg KOH/g, Tg: 35° C.

### Example polyester 2

2.22 mol of Dicidol, 2.15 mol of hexanediol and 1.65 mol of adipic acid are stirred under a nitrogen atmosphere at 210° C. until the acid number is about 5 mg KOH/g. Then 1.65 mol of maleic anhydride and 0.1% of hydroquinone are added and conditions are maintained until the acid number is below 1 mg KOH/g, a vacuum of 20 mbar being applied in the end phase of the condensation. Thereafter 0.5 mol of trimellitic anhydride is added and conditions are maintained until the acid number is approximately 30 mg KOH/g.

### Characteristics:

Mₙ: 2000 g/mol, acid number: 27 mg KOH/g, hydroxyl number: 55 mg KOH/g, Tg: −9° C.

### Example of the Preparation of an Aqueous Dispersion I

The polyester of example 1 is dissolved at 50% in acetone. Then DMEA is added (degree of neutralization: 1.0). Following the addition of water the acetone is removed by distillation. This gives a storage-stable dispersion possessing a solids of approximately 36%.

### Characteristics:

Acid number: 27 mg KOH/g, viscosity_{D=200}: 180 mPas, pH: 7.8, solids content: 36.0%

### Example of the Preparation of an Aqueous Dispersion II

The polyester of example 2 is dissolved at 60% in acetone. Then DMEA is added (degree of neutralization: 0.7). Following the addition of water the acetone is removed by distillation. This gives a storage-stable dispersion possessing a solids of approximately 37%.

### Characteristics:

Acid number: 25 mg KOH/g, viscosity_{D=200}: 155 mPas, pH: 7.5, solids content: 37.5%

### Example of the Preparation of an Aqueous Dispersion III

The polyester of example 2 is melted at about 120° C. in a closed container, admixed with DMEA in accordance with a degree of neutralization of 1.0, and provided with water, with vigorous stirring. Cooling to room temperature produces a storage-stable dispersion having a solids content of approximately 38%.

### Characteristics:

Acid number: 27 mg KOH/g, viscosity_{D=200}: 85 mPas, pH: 7.7, solids content: 38.5%

### Urethanized Polyester A

1.25 mol of adipic acid are reacted with 3.675 mol of Dicidol at a maximum of 210° C. under a nitrogen atmosphere until an acid number below 5 mg KOH/g is reached. Then 1.25 mol of fumaric acid and 0.05% by weight of hydroquinone monomethyl ether (based on fumaric acid) are added. After 2 hours of stirring a vacuum of 20 mbar is applied until an acid number below 5 mg KOH/g is reached. After cooling, the polyester is dissolved at 60% in acetone.

1128 g of this polyester solution are reacted with 431.9 g of an adduct consisting of two moles of isophorone diisocyanate and one mole of dimethylolpropionic acid (60% strength solution in acetone) at reflux temperature in the presence of 1.0 g of dibutyltin dilaurate for 14 h until an NCO content of less than 0.1% is reached.

### Characteristics:

Acid number: 26.6 mg KOH/g, solids content: 63.5%.

### Preparation of an Aqueous Dispersion IV

The above-described urethanized polyester A is diluted with acetone to a solids content of 50% and admixed with DMAE in accordance with a degree of neutralization of 1.05. With vigorous stirring, deionized water is added and after a further 30 minutes the acetone is removed by distillation under a gentle vacuum. This gives a storage-stable, solvent-free dispersion having a solids of approximately 27%.

### Characteristics:

Viscosity_{D=200}: 320 mPas, pH; 8.3, solids content: 27.3%.

### Urethanized Polyester B

1.25 mol of adipic acid are reacted with 3.675 mol of Dicidol at a maximum of 210° C. under a nitrogen atmosphere until an acid number below 5 mg KOH/g is reached. Then 1.25 mol of fumaric acid and 0.05% by weight of hydroquinone monomethyl ether (based on fumaric acid) are added. After 2 hours of stirring a vacuum of 20 mbar is applied until an acid number below 5 mg KOH/g is reached. After cooling, the polyester is dissolved at 60% in acetone.

1129 g of this polyester solution are reacted with 431.9 g of an adduct consisting of two moles of isophorone diisocyanate and one mole of dimethylolpropionic acid (60% strength solution in acetone) at reflux temperature in the presence of 1.0 g of dibutyltin dilaurate for 14 h until an NCO content of less than 0.1% is reached.

### Characteristics:

Acid number: 23.1 mg KOH/g, solids content: 60.8%.

### Preparation of an Aqueous Dispersion V

The above-described urethanized polyester B is diluted with acetone to a solids content of 50% and admixed with DMAE in accordance with a degree of neutralization of 1.00. With vigorous stirring, deionized water is added and after a further 30 minutes the acetone is removed by distillation under a gentle vacuum. This gives a storage-stable, solvent-free dispersion having a solids of approximately 27%.

### Characteristics:

Viscosity_{D=200}: 370 mPas, pH: 8.5, solids content: 27.3%,

### Application Example

Lipaton X 6030 (Polymer Latex GmbH & Co. KG) was admixed with either 10% or 20% of dispersions I-V. The mixtures were drawn down onto galvanized steel plates using a 100 μm doctor blade. After storage at room temperature for 72 h, the adhesion was determined by means of cross-cut (CC) testing (DIN EN ISO 2409).

| | | CC |
|---|---|---|
| no addition | | 5 |
| Dispersion I | +10% dispersion | 2 |
| | +20% dispersion | 1-2 |
| Dispersion II | +10% dispersion | 2 |
| | +20% dispersion | 1-2 |
| Dispersion III | +10% dispersion | 1-2 |
| | +20% dispersion | 1-2 |
| Dispersion IV | +10% dispersion | 1 |
| | +20% dispersion | 1 |
| Dispersion V | +10% dispersion | 1 |
| | +20% dispersion | 1 |

1: A method of protecting, finishing, and/or filling materials with an aqueous dispersion based on an amorphous unsaturated polyester resin, comprising admixing the aqueous dispersion with the materials,
wherein the polyester resin is obtained by reacting
I. an alcohol component,
II. 1. 20 to 100 mol % of an α,β-unsaturated carboxylic acid component and
2. 0 to 80 mol % of a further carboxylic acid component,
the sum of II.1 and II.2 being 100 mol %, and
III. 0 to 2 mol, based on 1 mol of polyester from I and II (via Mn), of at least one hydrophilically modified isocyanate and/or polyisocyanate having at least one free NCO group, obtainable by reacting at least one isocyanate and/or polyisocyanate with compounds which in addition to the hydrophilic or potentially hydrophilic group have at least one function which is reactive toward isocyanate groups,
the alcohol component I being composed of a Dicidol mixture of the isomeric compounds 3,8-bis(hydroxymethyl)tricyclo[5.2.1.0^{2,6}]decane, 4,8-bis(hydroxmethyl)-tricyclo[5.2.1.0^{2,6}]decane and 5,8-bis(hydroxymethyl)tricyclo[5.2.1.0^{2,6}]decane,
it being possible for each isomer to be present in a fraction of from 20% to 40% in the mixture, and the sum of the three isomers being from 90% to 100%,
and the mixture being present at least at 10 mol % in the alcohol component of the polyester,
and there being at least one component II.2 and/or III,
and the aqueous dispersion having
a) a nonvolatiles content of from 20% to 60% by weight,
b) a solvent content of from 0 to 20% by weight,
c) a pH of between 5.0 and 9.5, and
d) a viscosity at 20° C. of from 20 to 500 mPas.

2: The method of claim 1, wherein the unsaturated amorphous polyester includes up to 10% of further isomers of Dicidol and/or trimeric and/or higher isomeric diols of the Diels-Alder reaction product from cyclopentadiene.

3: The method of claim 1, wherein the alcohol component of the unsaturated amorphous polyester contains further linear and/or branched, aliphatic and/or cycloaliphatic and/or aromatic diols and/or polyols.

4: The method of claim 1, wherein the unsaturated amorphous polyester contains as additional alcohols ethylene glycol, 1,2- and/or 1,3-propanediol, diethylene glycol, dipropylene glycol, triethylene glycol, tetraethylene glycol, 1,2- and/or 1,4-butanediol, 1,3-butylethylpropanediol, 1,3-methylpropanediol, 1,5-pentanediol, cyclohexanedimethanol, glycerol, hexanediol, neopentyl glycol, trimethylolethane, trimethylolpropane and/or pentaerythritol, bisphenol A, B, C, F, norbornylene glycol, 1,4-benzyldimethanol and -ethanol, 2,4-dimethyl-2-ethylhexane-1,3-diol.

5: The method of claim 1, wherein at least 20% of the alcohol component of the unsaturated amorphous polyester is composed of the isomers of Dicidol.

6: The method of claim 1, wherein at least 50% of the alcohol component of the unsaturated amorphous polyester is composed of the isomers of Dicidol.

7: The method of claim 1, wherein at least 90% of the alcohol component of the unsaturated amorphous polyester is composed of the isomers of Dicidol.

8: The method of claim 1, wherein 100% of the alcohol component of the unsaturated amorphous polyester is composed of the isomers of Dicidol.

9: The method of claim 1, wherein the unsaturated amorphous polyester contains as α,β-unsaturated dicarboxylic acids (II.1) citraconic, fumaric, itaconic, maleic and/or mesaconic acid, more preferably fumaric acid and/or maleic acid (anhydride).

10: The method of claim 1, wherein as a further carboxylic acid component of the unsaturated amorphous polyester (II.2) aromatic and/or aliphatic and/or cycloaliphatic monocarboxylic acids and/or dicarboxylic acids and/or polycarboxylic acids, their anhydrides and/or alkyl esters are included.

11: The method of claim 1, wherein the unsaturated amorphous polyester contains as a further carboxylic acid component (II.2) phthalic acid, isophthalic acid, terephthalic acid, 1,4-cyclohexanedicarboxylic acid, succinic acid, sebacic acid, methyltetrahydrophthalic acid, methylhexahydrophthalic acid, hexahydrophthalic acid, tetrahydrophthalic acid, dodecanedioic acid, adipic acid, azelaic acid, pyromellitic acid and/or trimellitic acid, their acid anhydrides and/or methyl esters and also isononanoic acid and/or 2-ethylhexanoic acid, more preferably trimellitic acid (anhydride), adipic acid, dodecanedioic acid and/or phthalic acid (anhydride).

12: The method of claim 1, wherein the alcohol component of the unsaturated amorphous polyester is present in a molar ratio of from 0.5 to 2.0:1 with respect to the carboxylic acid component.

13: The method of claim 1, wherein the alcohol component of the unsaturated amorphous polyester is present in a molar ratio of from 0.8 to 1.5:1 with respect to the carboxylic acid component.

14: The method of claim 1,
wherein the alcohol component of the unsaturated amorphous polyester is present in a molar ratio of from 1.0 to 1.3:1 with respect to the carboxylic acid component.

15: The method of claim 1, wherein said resin has an acid number of between 1 and 200 mg KOH/g, preferably between 1 and 100, in particular between 10 and 50 mg KOH/g.

16: The method of claim 1,
wherein said resin has an OH number of between 1 and 200 mg KOH/g, preferably between 1 and 100, more preferably between 10 and 80 mg KOH/g.

17: The method of claim 1, wherein hydrophilicization is carried out using a carboxylic acid with a functionality of three and/or more.

18: The method of claim 1, wherein hydrophilicization is carried out using pyromellitic acid and/or trimellitic acid, more preferably trimellitic anhydride.

19: The method of claim 1, wherein the amorphous unsaturated polyester is hydrophilicized by reaction with a hydrophilically modified isocyanate and/or polyisocyanate having at least one free NCO group, obtainable by reacting at least one isocyanate and/or polyisocyanate with compounds which in addition to the hydrophilic or potentially hydrophilic group have at least one function that is reactive toward isocyanate groups.

20: The method of claim 1 wherein the hydrophilically modified diisocyanate is prepared using an aromatic, aliphatic and/or cycloaliphatic diisocyanate.

21: The method of claim 20, wherein isophorone diisocyanate and/or 1,6-diisocyanato-2,4,4-trimethylhexane or 1,6-diisocyanato-2,2,4-trimethylhexane (TMDI) and/or hexamethylene diisocyanate and/or 4,4′-methylenebis(cyclohexyl diisocyanate), alone or in a mixture, is used as diisocyanate.

22: The method of claim 1, wherein the hydrophilically modified diisocyanate is prepared using tertiary amino alcohols, aminocarboxylic acids and/or hydroxycarboxylic acids such as bishydroxyalkylcarboxylic acid.

23: The method of claim 1, wherein the hydrophilically modified diisocyanate is prepared using 2,2-dimethylolacetic acid, 2,2-dimethylolpropionic acid, 2,2-dimethylolbutyric acid, 2,2-dimethylolpentanoic acid, dihydroxysuccinic acid, 1,1,1-trimethylolacetic acid, hydroxypivalic acid.

24: The method of claim 1, wherein auxiliaries and additives are included.

25: The method of claim 24, wherein auxiliaries and additives selected from inhibitors, organic solvents, water, surfactants, oxygen scavengers and/or free-radical scavengers, catalysts, light stabilizers, color brighteners, photosensitizers and photoinitiators, additives for influencing rheological properties, such as thixotropic agents anchor thickening agents, flow control agents, anti-skinning agents, defoamers. antistats, lubricants, wetting agents, dispersants, neutralizing agents, preservatives such as agents, for example, including fungicides and/or biocides, thermoplastic additives, plasticizers, matting agents, flame retardants, internal release agents, fillers, dyes, pigments and/or propellants are included.

26: The method of claim 1, wherein the alcohol component of the unsaturated amorphous polyester is composed of at least 50% of Dicidol mixture as set forth in claims 1 and 2 and fumaric acid and/or maleic acid (anhydride) and trimellitic anhydride or dimethylolpropionic acid and isophorone diisocyanate and/or hexamethylene diisocyanate and/or 4,4′-methylenebis(cyclohexyl diisocyanate) is included.

27: The method of claim 1, wherein adipic acid, dodecanedioic acid and/or phthalic acid (anhydride) are additionally included in the unsaturated amorphous polyester as a carboxylic acid component and are in a ratio of α,β-unsaturated acid to additional carboxylic acid of from 3:1 to 1:4.

28: The method of claim 27, wherein at least some of the acid groups of the unsaturated amorphous polyester have been neutralized.

29: The method of claim 28, wherein an amine and/or an inorganic hydroxide solution is used for the neutralization.

30: The method of claim 28, wherein the degree of neutralization is between 0.3 and 1.1.

31: The method of claim 1, wherein the aqueous dispersion is a main, base or additional component in coating materials, adhesives, inks, including printing inks, gel coats, polishes, stains, pigment pastes, filling compounds, cosmetics articles, sealants and/or insulants.

32: The method of claim 1, wherein the aqueous dispersion is a main, base or additional component in filling compounds, primers, surfacers, basecoat, topcoat and clearcoat materials.

33: The method of claim 1, wherein the material is metals, plastics, wood, board, paper, textiles, leather, mineral substrates and/or glass.

34: The method of claim 1, wherein the aqueous dispersion is a main, base or additional component in radiation-curing coating materials, adhesives, inks, including printing inks, gel coats, polishes, stains, pigment pastes, filling compounds, cosmetics articles, sealants and/or insulants, wherein further water-soluble or water-dispersible oligomers and/or polymers are included.

35: The method of claim 1, wherein the aqueous dispersion is a main, base or additional component in radiation-curing coating materials, adhesives, inks, including printing inks, gel coats, polishes, stains, pigment pastes, filling compounds, cosmetics articles, sealants and/or insulants, wherein further water-soluble or water-dispersible oligomers and/or polymers selected from the group consisting of polyurethanes, polyacrylates, polyethers, polyesters, alkyd resins, cellulose ethers, cellulose derivatives, polyvinyl alcohols and derivatives, rubbers, maleate resins, phenol-/urea-aldehyde resins, amino resins, epoxy acrylates, epoxy resins, silicic esters and alkali metal silicates, natural resins, silicone oils and silicone resins, amine resins and/or fluorine-containing polymers and their derivatives, alone or in combination are included.

36: A coated article produced with an aqueous dispersion based on an amorphous unsaturated polyester resin, wherein the polyester resin is obtained by reacting
I. an alcohol component,
II. 1. 20 to 100 mol % of an α,β-unsaturated carboxylic acid component and
2. 0 to 80 mol % of a further carboxylic acid component,
the sum of II.1 and II.2 being 100 mol %, and
III. 0 to 2 mol, based on 1 mol of polyester from I and II (via Mn), of at least one hydrophilically modified isocyanate and/or polyisocyanate having at least one free NCO group, obtainable by reacting at least one isocyanate and/or polyisocyanate with compounds which in addition to the hydrophilic or potentially hydrophilic group have at least one function which is reactive toward isocyanate groups,
the alcohol component I being composed of a Dicidol mixture of the isomeric compounds 3,8-bis(hydroxymethyl)tricyclo[5,2,1,0^{2,6}]decane, 4,8-bis(hydroxymethvl)-tricyclo[5.2.1.0^{2,6}]decane and 5,8-bis(hydroxymethyl)tricyclo[5.2.1.0^{2,6}]decane,
it being possible for each isomer to be present in a fraction of from 20% to 40% in the mixture, and the sum of the three isomers being from 90% to 100%,
and the mixture being present at least at 10 mol % in the alcohol component of the polyester,
and there being at least one component II.2 and/or III,
and the aqueous dispersion having
a) a nonvolatiles content of from 20% to 60% by weight,
b) a solvent content of from 0 to 20% by weight,
c) a pH of between 5.0 and 9.5, and
d) a viscosity at 20° C. of from 20 to 500 mPas.
